(19) United States
(12) Patent Application Publication
(10) Pub. No.: US 2026/0178881 A1
(43) Pub. Date: Jun. 25, 2026

(54) HUMAN BEHAVIOR PREDICTION ACROSS VARIOUS DOMAINS USING ARTIFICIAL INTELLIGENCE

(71) Applicant: Anticip8 AI LLC, Dover, DE (US)

(72) Inventors: Nikolas Kairinos, Pafos (CY); Constantinos Hadjigregoriou, Nicosia (CY); Charalambos Theodorou, Limassol (CY)

(21) Appl. No.: 19/420,957

(22) Filed: Dec. 16, 2025

Related U.S. Application Data
(60) Provisional application No. 63/736,757, filed on Dec. 20, 2024.

(51) Int. Cl. G06N 3/045; G06F 18/25; G06N 3/092

(52) U.S. Cl. CPC G06N 3/045; G06F 18/253; G06N 3/092

(57) ABSTRACT

A system for predicting human behavior across multiple domains includes a multimodal encoder configured to receive and process text, image, audio, and video contextual data. The multimodal encoder includes a plurality of modality-specific sub-encoders that generate modality-specific embeddings and a feature fusion module configured to combine the modality-specific embeddings into a unified representation. The system includes a transformer architecture communicably coupled to the multimodal encoder, the transformer architecture including a plurality of self-attention mechanisms configured to generate context-aware representations from the unified representation. The system includes a plurality of task-specific output heads communicably coupled to the transformer architecture, each output head corresponding to a domain out of the multiple domains. Each output head is configured to generate a probability distribution of next human actions based on the context-aware representations.

### CROSS-REFERENCE TO RELATED APPLICATIONS

This application claims the benefit of U.S. Provisional Application No. 63/736,757, filed Dec. 20, 2024 and titled “Human Behavior Prediction Across Various Domains Using Artificial Intelligence” by Kairinos et al.

### SUMMARY

A system for predicting human behavior across multiple domains, includes a multimodal encoder configured to receive and process text, image, audio, and video contextual data. The multimodal encoder includes a plurality of modality-specific sub-encoders that generate modality-specific embeddings and a feature fusion module configured to combine the modality-specific embeddings into a unified representation. The system includes a transformer architecture communicably coupled to the multimodal encoder, the transformer architecture including a plurality of self-attention mechanisms configured to generate context-aware representations from the unified representation. The system includes a plurality of task-specific output heads communicably coupled to the transformer architecture, each output head corresponding to a domain out of the multiple domains. Each output head is configured to generate a probability distribution of next human actions based on the context-aware representations.

A method for predicting human behavior using multimodal contextual data includes receiving contextual data including text, image, audio, and video information and generating modality-specific embeddings based on the contextual data. The method further includes combining the modality-specific embeddings into a unified representation and generating context-aware representations from the unified representation using a plurality of self-attention mechanisms. The method further includes generating a probability distribution of next human actions based on the context-aware representations and displaying at least one of the next human actions.

A non-transitory computer-readable medium stores instructions that, when executed by one or more processors, cause the one or more processors to receive contextual data including text, image, audio, and video information and generate modality-specific embeddings based on the contextual data and combine the modality-specific embeddings into a unified representation. The one or more processors are further caused to generate context-aware representations from the unified representation using a plurality of self-attention mechanisms and generate a probability distribution of next human actions based on the context-aware representations.

### BRIEF DESCRIPTION OF THE DRAWINGS

Accordingly, systems, methods, and computer-readable mediums for human behavior prediction are disclosed herein. In the drawings:

FIG. 1 is a diagram illustrating a system for human behavior prediction in accordance with at least one illustrated embodiment;

FIG. 2 is a diagram illustrating multimodal feature fusion in accordance with at least one illustrated embodiment;

FIG. 3 is a flow diagram illustrating a method for human behavior prediction in accordance with at least one illustrated embodiment;

FIG. 4 is a diagram illustrating a reinforcement learning feedback loop in accordance with at least one illustrated embodiment;

FIG. 5 is a diagram illustrating knowledge distillation in accordance with at least one illustrated embodiment;

FIG. 6 is a diagram illustrating domain-specific application examples in accordance with at least one illustrated embodiment;

FIG. 7 is a diagram illustrating transformer self-attention mechanisms in accordance with at least one illustrated embodiment;

FIG. 8 is a diagram illustrating tokenization in accordance with at least one illustrated embodiment;

FIGS. 9A and 9B are diagrams illustrating a computer-readable medium for human behavior prediction in accordance with at least one illustrated embodiment; and

FIG. 10 is a flow diagram illustrating a method for human behavior prediction in accordance with at least one illustrated embodiment.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### Notation And Nomenclature

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including,” “comprising,” and “such as” are used in an open-ended fashion, and thus should be interpreted to mean “including, but not limited to.”.

### DETAILED DESCRIPTION

The disclosure relates to using artificial intelligence (AI) techniques to predict human behavior across various domains by processing human or demographic profile(s), contextual data, and next human actions to deliver a probability of each next human action occurring. Specifically, the systems, methods, mediums etc. disclosed may employ a transformer based architecture with self-attention mechanisms and reinforcement learning to analyze human profiles, contextual data, and potential next human actions. Based on this input, a probability distribution of next human actions is generated where the probabilities reflect the likelihood of different subsequent actions of one or more people. In various embodiments, the system includes a unified multimodal processing module, task specific templates, and a continuous learning loop through feedback integration. The system is scalable and adaptable enabling real-time updates and use across diverse domains such as marketing, fraud prevention, social media influence forecasting, student performance monitoring, healthcare, education, and retail.

The system may include one or more neural networks, which require substantial computational resources due to their architectural complexity and the large volumes of data involved in training. To support these operations, the system may employ various hardware components, including graphics processing units (GPUs), tensor processing units (TPUs), central processing units (CPUs), and memory resources. GPUs may provide parallel processing capabilities for large matrix operations and for performing forward and backward propagation during neural network training and inference. TPUs may be used for deep learning workloads and are optimized for tensor operations in large scale training environments such as data centers. CPUs may support training, data preprocessing, and deployment of trained networks particularly in environments with limited computational capacity such as thin clients. Memory components may store and retrieve weights, activations, and intermediate data during both training and inference enabling efficient data handling and learning across network layers.

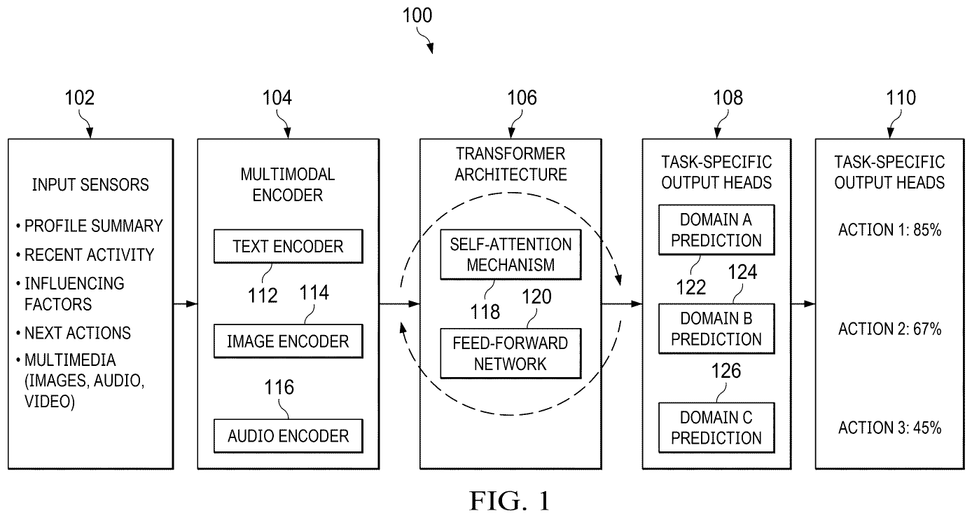

FIG. 1 illustrates an example system 100 for predicting human behavior across multiple domains. In addition to the above hardware, the system includes a multimodal encoder 104 configured to receive and process contextual data 102 originating from a variety of sources, such as text inputs, images, audio signals, video data, and other sensor-derived information. The contextual data may include human profile summaries, recent activity, influencing factors, potential next human actions, historical events, environmental cues, multimedia files, and the like associated with a human whose next actions are being predicted. The multimodal encoder may incorporate distinct sub-encoders, e.g. a text encoder 112, an image encoder 114, and an audio encoder 116, each designed to extract modality-specific features that preserve the semantic, visual, or acoustic characteristics of the corresponding input modality.

The outputs of these sub-encoders may be supplied to a feature fusion module, which combines the modality-specific embeddings into a unified representation. In various embodiments, the feature fusion module may employ concatenation, weighted averaging, learned projection layers, or cross-modal attention mechanisms to integrate the features. Through this integration process, information that may be incomplete or ambiguous within a single modality may be jointly interpreted across modalities enabling the system to identify relationships and contextual cues that would otherwise be unavailable. For example, in the retail domain, textual indications of dissatisfaction may be combined with a visual depiction of a damaged product thereby strengthening evidence for a predicted “return” or “refund” action.

The unified representation is then provided to a transformer architecture 106. In the embodiment illustrated, the transformer includes a series of self-attention mechanisms 118 configured to compute context-aware representations. These attention mechanisms selectively weight different components of the unified representation based on their relevance to the prediction task at hand. Certain portions of textual input may be emphasized when predicting communication-related behaviors, while visual or audio features may be emphasized for safety-related or sentiment-related predictions. Although the transformer was originally designed to process linguistic tokens, the disclosed system may instead represent each potential next human action as a discrete behavioral token. This adaptation enables the transformer to infer sequences of next human actions using the same mechanisms it would ordinarily use to generate sequences of words. Each transformer layer may include a feed-forward network 120 that applies nonlinear transformations to the contextual representations allowing the system to learn more complex patterns.

The transformer architecture is communicably coupled to a set of task specific output heads 108, each designed to generate outputs for a particular prediction task and, in at least one embodiment, positioned in the final layer or layers of the neural network. Deep learning frameworks may facilitate defining, training, and maintaining multiple output heads within a single system, with each head tuned for a different behavioral prediction domain 122-126 such as financial services, retail commerce, healthcare, education, marketing, fraud detection, and/or customer purchasing behavior. These heads may include fully connected layers, classification layers employing softmax functions, and regression layers configured to predict continuous values, and each head may be associated with a loss function appropriate to its designated task such as cross entropy loss for classification or mean squared error for regression. Task specific output heads may further receive tailored data-processing pipelines aligned with their respective domains such that, for example, a head focused on detecting fraudulent behavior may receive transaction level preprocessing while a head focused on advertising campaign outcomes may receive historical campaign data. Based on the context aware representations produced by the transformer architecture, each output head may generate a probability distribution 110 over next human actions. The distribution may be normalized and supplemented with confidence metrics derived from entropy based uncertainty estimation or probability calibration techniques. Because new prediction tasks may arise over time, additional task specific output heads may be added or modified without retraining the entire neural network thereby enabling modular expansion and supporting multi-domain behavioral prediction capabilities.

The architecture of FIG. 1 allows the system to scale efficiently across industries or use cases. Because the core transformer architecture is shared among all behavioral-prediction domains, additional prediction domains may be supported by adding new task-specific output heads without retraining the underlying transformer. Domain adaptation therefore occurs at the output stage, while the unified multimodal processing and transformer components remain consistent and reusable.

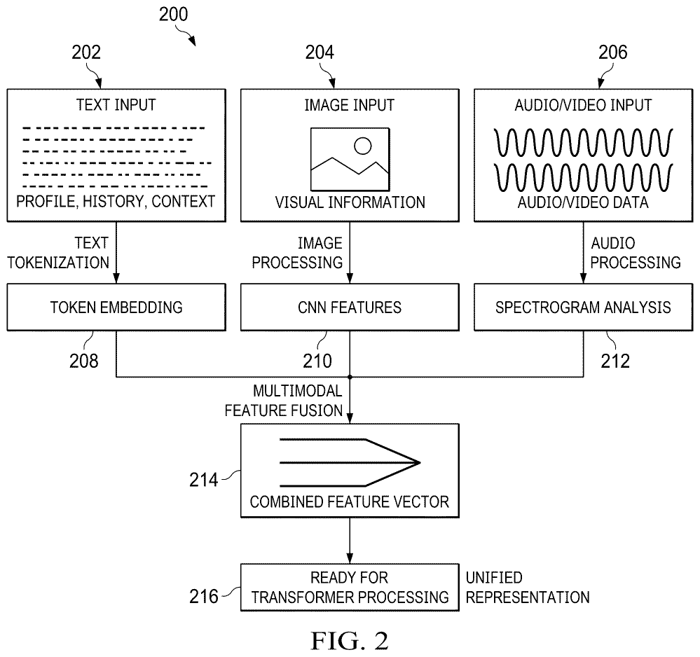

FIG. 2 illustrates an example multimodal feature-fusion process 200 used to generate the unified representation that is later processed by the transformer architecture. As shown, the system receives contextual data in multiple modalities, including text 202, image 204, and audio or video inputs 206. Each modality may reflect different aspects of the human's state or environment. Text inputs may include written descriptions, historical summaries, or conversational transcripts. Image inputs may include photographs, screenshots, or other visual information. Audio and video inputs may include recorded speech, environmental sounds, or time-varying visual sequences. These heterogeneous inputs collectively form the multimodal contextual data used by the system to predict human behavior.

To extract meaningful features from each modality, the system processes the multimodal data using a set of modality-specific encoders. A text encoder may tokenize the textual input and transform it into embeddings 208 that capture syntactic and semantic information. An image encoder may apply feature extraction via convolutional neural network (CNN) to identify visual features 210 relevant to the prediction task. An audio encoder may transform raw audio or video-derived sound into spectrograms 212 or other time-frequency representations. Through these specialized encoders, each modality may be converted into embeddings that reflect the unique structural and statistical patterns present in the corresponding data type.

Once the system generates modality-specific embeddings, they are supplied to a feature-fusion module 214 that integrates the embeddings into a unified representation 216. In various embodiments, the feature-fusion process may include concatenation, learned projections, cross-modal weighting, or attention-based integration. The objective of the fusion stage is to combine the strengths of each modality for the transformer architecture. For example, emotionally charged language in the text input may correlate with facial expressions identified in image input, or the tone of voice extracted from audio may reinforce contextual signals found in the textual description. By jointly interpreting the information across modalities, the system may identify behavioral indicators that may not be evident when each modality is evaluated in isolation.

The unified representation produced through the feature-fusion module serves as the multimodal embedding that is provided to the transformer architecture. This unified representation allows the transformer to model relationships and dependencies across all aspects of the multimodal input, enabling the system to generate context-aware representations.

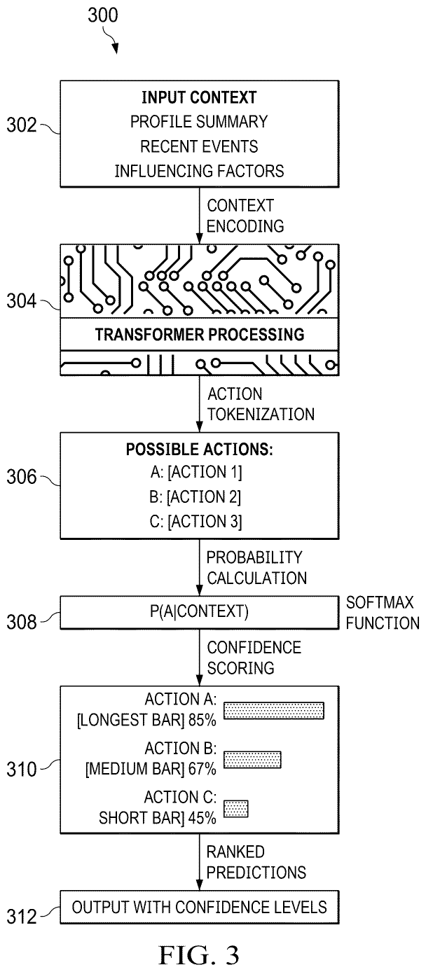

FIG. 3 illustrates a method 300 of predicting human behavior in at least one embodiment. The method begins with input context 302 that may include elements such as a profile, recent events, and influencing factors derived from the human's environment or historical data. This contextual information is encoded 304 into an internal representation suitable for processing by the transformer architecture.

Once encoded, the system identifies 306 a set of possible next actions. These actions may be derived from action tokens generated through linguistic parsing or from domain specific behavioral categories provided as part of the prediction task. The transformer processes the contextual representation together with the set of possible actions to evaluate how strongly each action aligns with the underlying context.

The system then computes probabilities for each next human action by applying 308 a softmax function or related normalization mechanism to the transformer's output. This step produces a probability distribution that reflects the relative likelihood of each next human action occurring in the given context. Following probability computation, the system may assign 310 confidence scores that may incorporate factors such as entropy based uncertainty or calibration adjustments.

The actions are then ranked in descending order of their likelihood producing an ordered list that highlights the most probable. The final result may be output 312 as structured data that includes both the actions and their associated confidence levels providing a clear and interpretable summary and assessment of future human behavior.

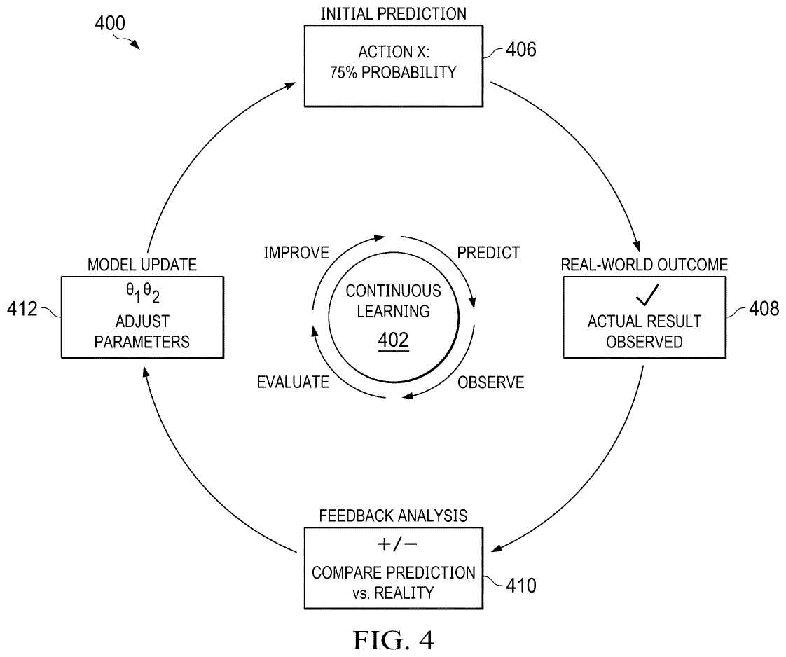

FIG. 4 illustrates an example reinforcement learning feedback loop 400 that enables the system to continually refine 402 its predictions of human behavior. As shown, the system generates 406 a next human action probability based on the multimodal contextual data processed by the multimodal encoder and transformed into context-aware representations by the transformer architecture. This prediction may be one of the behavioral outputs produced by the task-specific output heads, each of which generates a probability distribution of next human actions for its respective domain. The initial prediction represents the system's best assessment of the human's likely behavior at that moment.

After a prediction is generated, the system observes 408 the corresponding real-world outcome or human interaction that follows. The reinforcement learning module evaluates 410 the alignment between the predicted action and the actual observed behavior. When the prediction closely matches the real-world result, the system may receive a positive reward; when the prediction diverges from the actual behavior, the system may receive a penalty. This reward or penalty quantifies the predictive accuracy of the system under current conditions and forms the basis for updating its internal parameters.

The reinforcement learning module may employ proximal policy optimization or a similar algorithm to adjust the system's parameters based on the received feedback. By using a policy-optimization approach, the system updates 412 the multimodal encoder, the transformer architecture, and the task-specific output heads in a manner that improves predictive performance while maintaining stability in the learning process. These updates help the system adapt to evolving user behavior patterns, shifting context, and dynamic real-world environments. The feedback loop therefore allows the model to improve its accuracy progressively through repeated cycles of prediction, observation, evaluation, and refinement.

In some embodiments, the reinforcement learning module may operate alongside long short-term memory (LSTM) or other sequence preserving mechanisms to balance new learning with retention of previously acquired knowledge. This ensures that the system does not overwrite or discard earlier behavioral patterns that remain relevant while still remaining responsive to emerging trends or shifts in user behavior. By integrating mechanisms for temporal retention with policy-based reinforcement learning, the system becomes capable of generalizing effectively across diverse data points and adapting to subjects whose behavior evolves over time. The closed-loop interaction between prediction and real-world feedback enables the system to remain accurate and robust in a variety of domains and changing conditions.

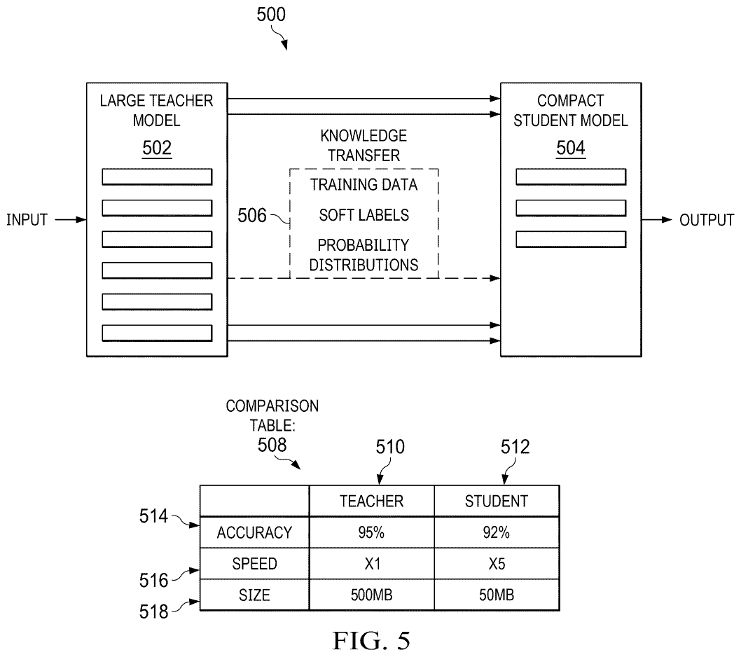

FIG. 5 illustrates an example knowledge distillation architecture 500 that enables accurate prediction in resource-constrained environments. As shown, the architecture includes a larger, more complex neural network referred to as the teacher model 502 and a smaller, more efficient neural network referred to as the student model 504. The teacher model may represent a full-scale version of the multimodal encoder, transformer architecture, and task-specific output heads. The teacher model may be trained on powerful computing hardware using large quantities of multimodal data, and is capable of generating accurate probability distributions of next human actions. However, because of its computational demands, the teacher model may not be suitable for deployment on devices with limited processing or memory capacity.

To enable practical deployment, the system may include a knowledge distillation framework 506 in which the behavior of the teacher model is transferred to the student model. During this process, the teacher generates outputs such as probability distributions, confidence scores, and/or intermediate representations that serve as soft labels. These soft labels provide richer information than standard training labels alone because they reflect the teacher's learned understanding of relationships among human actions. The student model is trained to minimize divergence between its outputs and the outputs of the teacher through, e.g., loss functions that measure differences in predicted probabilities. This training procedure allows the student to approximate the teacher's decision making despite having fewer parameters, reduced depth, and/or simplified internal components.

In one embodiment, the teacher model is first trained on a high-performance server equipped with GPUs, TPUs, or other accelerators capable of powering large-scale multimodal learning. Once trained, the student model is initialized and exposed to the same or similar training data augmented by the teacher's soft labels. By optimizing the student model using both labels and the teacher's outputs, the system encourages the student to match the teacher's predictive behavior and generalization patterns. The combination of supervised learning and distillation learning enables the student to achieve performance levels comparable to the teacher while requiring substantially fewer computational resources.

Once the distillation is complete, the student model may be deployed on low power devices such as mobile phones, thin clients, and embedded systems. Despite its smaller size, the student model is able to generate probabilities of next human actions that remain consistent with those produced by the teacher model. This allows the system to extend accurate behavioral prediction to environments where computational power, memory, or energy availability is limited. The comparison table 508 illustrated in FIG. 5 shows differences in accuracy, speed, and model size.

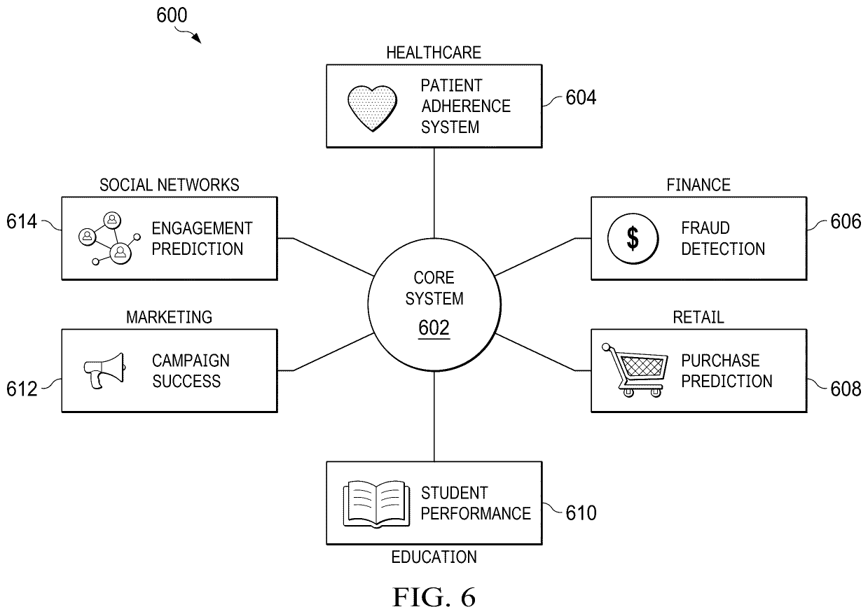

FIG. 6 illustrates a variety of example application domains in which the disclosed system 602 may be deployed to generate predictions of human behavior. As shown, the same underlying architecture may be used across a broad range of industries and operational contexts. Each domain uses the system's core capability of assigning probabilities to potential future behaviors based on multimodal contextual data, enabling real-time decision support and adaptive feedback across diverse environments. In deployment, the system may assign a probability value between zero and one to each next human action, forming a distribution that reflects the relative likelihood of multiple possible outcomes. These probabilities may be used directly for decision-making or may serve as inputs to additional automated processes. To enhance transparency, the system may incorporate attention visualization techniques or feature importance metrics indicating which components of the multimodal input most heavily influenced a given prediction. Where appropriate, the system may extend the list of potential next human actions by automatically generating new actions and allocating probabilities to them as well.

One such domain is marketing and advertising 612. The system may analyze historical campaign data, audience profiles, market conditions, and multimodal creative assets to predict engagement rates, conversion probabilities, and overall campaign success. For example, the system may evaluate both the textual messaging and the visual or auditory characteristics of an advertisement to determine how a target demographic is likely to respond. Predictions may be generated before campaign launch allowing marketers to refine content, adjust targeting, or select more effective channels. As a campaign progresses, the system may incorporate real-time metrics such as click-through rates, impressions, or social-media interactions. Deviations between predicted outcomes and observed results may trigger updates to the system's parameters and recommendations for corrective action, such as modifying messaging or retargeting audiences.

Another prominent domain is fraud detection 606 in financial or transactional systems. By analyzing multimodal data such as transaction histories, numerical patterns, textual descriptions, images of user-submitted documents, and contextual metadata such as location or device type, the system may compute real time fraud/risk scores that indicate the likelihood that a transaction is legitimate or fraudulent. Cross modal attention mechanisms allow the system to identify subtle combinations of features that indicate abnormal or malicious behavior. High-risk transactions may be denied automatically, while medium-risk transactions may be flagged for review with explanatory insights identifying factors that influenced the risk score. As fraud patterns evolve, dynamic updates allow the system to incorporate newly observed behaviors and adjust future predictions accordingly.

The system may also be deployed in social-network environments 614 to predict content virality, user engagement, and shifts in public opinion. Social-media posts typically contain multimodal elements such as text paired with images or videos, and the system may analyze these components collectively to determine how widely a post will spread or how users are likely to react. Predicted behaviors may include whether a post will be shared, commented on, or endorsed by influential users. The system may also evaluate network dynamics, including follower interactions and affinity relationships, to forecast how specific posts or users may influence broader sentiment within a digital community. As trends emerge, the system may recalibrate its predictions to reflect real time changes in user behavior and cultural context.

In educational environments 610, the system may analyze student performance indicators to predict academic outcomes, engagement levels, or risks of disengagement. Inputs may include written assignments, audio or video from lectures, online participation metrics, and historical academic records. Based on these multimodal signals, the system may forecast grades, likelihood of course completion, or other educational outcomes. Educators may receive recommended interventions tailored to individual learning preferences such as additional visual learning resources for visually oriented students. As students improve or decline in performance over time, the system may update its predictions and recommendations to support timely and effective interventions.

FIG. 6 further illustrates applications in retail commerce and customer purchase prediction 608. The system may analyze browsing behavior, product interaction data, demographic information, and real time contextual variables to predict whether a customer will make a purchase, which products the customer is most likely to select, and when a purchase is most likely to occur. These predictions support personalized recommendations, dynamic pricing, inventory optimization, and targeted promotional strategies. Real time adaptation allows the system to update purchase likelihood predictions as customers interact with an online platform such as by adding items to a shopping cart, browsing new categories, or responding to promotional messaging.

Finally, FIG. 6 includes healthcare-related applications 604 such as predicting patient adherence, engagement, or risk of adverse events. Multimodal data may include clinical notes, biometric information, historical medical records, and patient reported audio or video. Probability distributions generated by the healthcare output head may assist clinicians in prioritizing interventions, identifying at risk patients, or optimizing treatment plans.

FIG. 6 demonstrates that the system is not limited to any particular industry. Instead, the system may be deployed across a wide range of domains, each benefiting from the system's real-time adaptability, explainability mechanisms, and ability to integrate diverse forms of contextual data to accurately forecast human behavior.

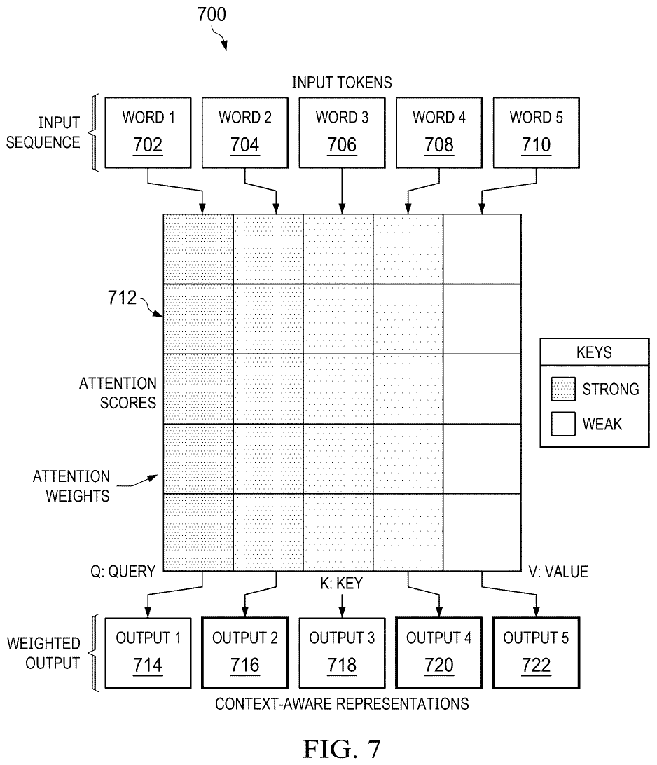

FIG. 7 illustrates an example self-attention mechanism 700 used within the transformer architecture. As shown, an input sequence 702-710 is represented as a series of tokens that may correspond to words, phrases, or, in some embodiments, action tokens representing next human actions. These tokens are transformed into internal representations that serve as inputs to the attention module. The self-attention mechanism evaluates the relationships among all tokens in the sequence allowing each token to weigh the relevance of every other token when forming its representation.

The shaded grid in FIG. 7 depicts the attention-weight matrix 712 generated during this process. Darker regions indicate stronger attention weights, reflecting a greater contribution of one token to another, while lighter regions indicate weaker influence. By computing weighted combinations of token representations, the transformer produces context-aware outputs 714-722 that incorporate information from across the entire sequence. These outputs collectively form a set of refined embeddings that capture global dependencies and nuanced interactions that may not be apparent from local context alone. The resulting context-aware representations may be used by downstream components to determine next human actions, support ranking of predicted actions, or inform domain specific decision processes.

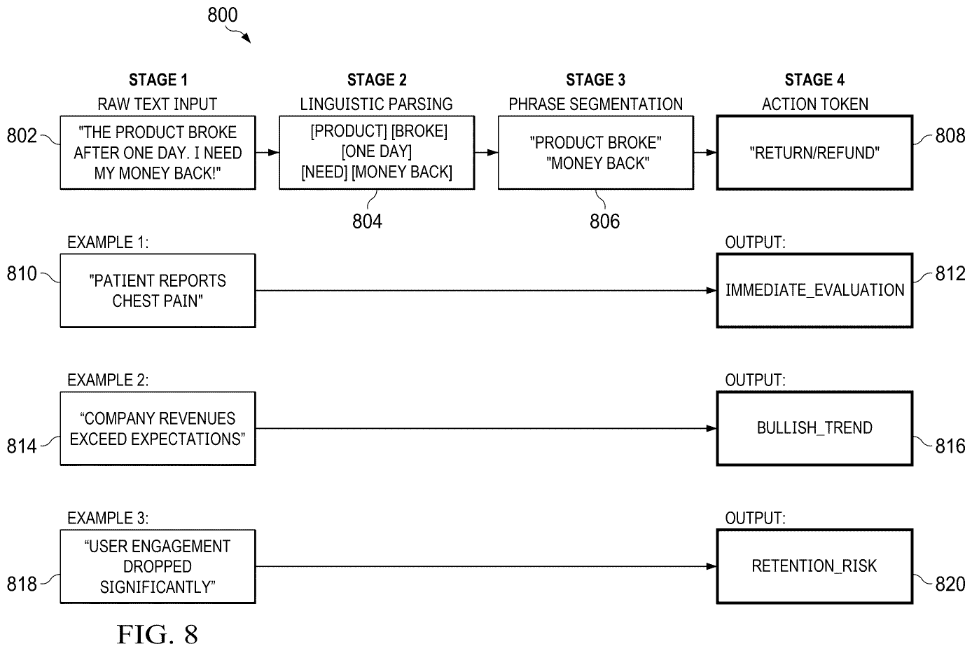

FIG. 8 illustrates an example pipeline 800 for converting raw textual input into structured action tokens suitable for downstream prediction. The first stage begins with unprocessed text 801, 810, 814, 818 such as user statements, customer feedback, medical summaries, or market commentary. In the second stage, the system performs linguistic parsing 804 to identify grammatical and semantic units embedded in the text. This parsing extracts informative elements such as noun phrases, verb phrases, and key descriptors that provide insight into the underlying intent or event being described. In the third stage, the parsed text is segmented 806 into coherent phrases that reflect meaningful components of the original input. This segmentation step isolates phrases that encapsulate actionable concepts such as problems, requests, observed conditions, or market signals. These phrases allow the system to distill complex textual descriptions into compact semantic units. The fourth stage maps each segmented phrase to a corresponding action token 808, 812, 816, 820. Action tokens represent canonical behavioral categories that serve as the building blocks for subsequent behavioral prediction processes. Examples depicted in FIG. 8 include classifications such as “RETURN/REFUND,” “IMMEDIATE_EVALUATION,” “BULLISH_TREND,” and “RETENTION_RISK.” These tokens standardize diverse textual inputs into a uniform representation that can be readily processed by transformers enabling consistent treatment across multiple domains.

The system may incorporate a semantic-similarity model to improve task relevance filtering by assessing the alignment between the input context and candidate tasks. Both the contextual information and the task descriptions may be encoded into high dimensional embeddings. The system may then compute a cosine-similarity score to quantify their alignment and exclude tasks that fall below a predefined threshold. This filtering step reduces computational overhead by discarding irrelevant tasks and increases predictive accuracy by ensuring that further processing is applied only to tasks that are semantically connected to the input context.

To assess prediction confidence, the system may compute entropy values over the probability distribution of predicted actions. Higher entropy indicates lower confidence and greater uncertainty. Entropy may be calculated from the model's logits after softmax normalization to ensure numerical stability. Predictions exceeding a confidence threshold may be flagged for review or refinement allowing the system to identify potentially unreliable outputs and prioritize more actionable predictions.

The system may also employ task specific templates to standardize input structure across domains. These templates may organize contextual elements into a unified format. For example, a template for purchase behavior prediction may emphasize past shopping patterns while a fraud detection template may emphasize transactional anomalies. Embedding task specific instructional cues within each template guides the system to focus on domain relevant signals thus improving prediction quality and consistency.

To further control prediction behavior, the system may dynamically adjust parameters such as temperature and beam size during generation. Lowering temperature reduces overconfidence and encourages exploration of a broader set of outputs, while adjusting beam size regulates how many candidate sequences are considered. These controls help ensure that predictions remain nuanced, probabilistically well calibrated, and resistant to deterministic or biased outputs.

The system may additionally incorporate a feedback loop combined with calibration techniques such as Platt scaling and isotonic regression. Users may provide real time evaluations of predictions, e.g. identifying outputs as too high, too low, or acceptable, and these evaluations may be used to iteratively refine likelihood estimates. Platt scaling may map raw output scores to calibrated probabilities using logistic regression, while isotonic regression may adjust likelihoods in a non-parametric, monotonic manner. By integrating these calibration techniques with user feedback, the system improves probability accuracy and reduces bias across domains.

In some embodiments, an embedding model may also be used to evaluate contextual relevance before prediction by encoding both candidate tasks and input context into a shared embedding space. Cosine-similarity comparisons may then identify which tasks are meaningfully supported by the context. This relevance checking process enhances computational efficiency and prediction quality by filtering out tasks that are not aligned with the input. Because the embedding model can process text, images, audio, and other data types, it supports robust and modality agnostic relevance assessment.

The system may further use a retrieval augmented generation approach to obtain additional context relevant to the actions under consideration. User provided files may be processed into descriptive text and segmented into semantically coherent chunks. These chunks may then be encoded into dense vector representations and stored in a vector database such as FAISS. When predicting behaviors or assigning probabilities, the system may conduct high-dimensional similarity searches using dynamic thresholds to retrieve the most relevant contextual passages and ensure that the model receives sufficient supporting information.

Multimodal inputs may be integrated into the retrieval process as well. Media files may first be described using a vision language model, and the resulting textual description may be embedded and indexed using the same vectorization process as other contextual chunks. Approximate nearest neighbor search may be employed to optimize retrieval time when selecting the top ranked passages from the vector database. In addition, FAISS may support indexing compressed binary vectors using Hamming distance, which reduces embedding size significantly while allowing fast comparison operations. The Hamming distance between binary vectors may be computed using optimized CPU level operations enabling efficient large scale retrieval even in resource constrained environments.

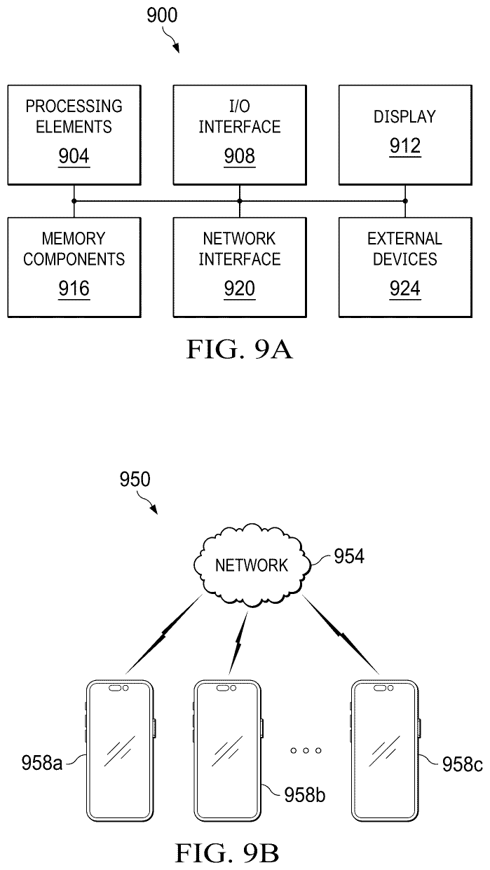

FIG. 9 illustrates a non-transitory computer-readable medium, which when executed by a processor, causes the processor to perform any appropriate action described herein. For example, the processor may perform any applicable action described in the methods or systems herein. A computer system 900 may be used to implement the platform generally. The computer system 900 is used to implement or execute one or more of the components or operations disclosed herein, and the computer system 900 may include one or more processing elements 904, an input/output interface 908, a display 912, one or more memory components 916, a network interface 920, and one or more external devices 924. Each of the various components may be in communication with one another through one or more buses, communication networks, such as wired or wireless networks.

The processing element 904 may be any type of electronic device capable of processing, receiving, and/or transmitting instructions. For example, the processing element 904 may be a central processing unit, graphics processing unit, microprocessor, processor, or microcontroller. Additionally, it should be noted that some components of the computer 900 may be controlled by a first processor and other components may be controlled by a second processor, where the first and second processors may or may not be in communication with each other.

Memory components 916 are used by the system 900 to store instructions for the processing element 904, as well as store data. Memory components 916 may be, for example, magneto-optical storage, read-only memory, random access memory, erasable programmable memory, flash memory, or a combination of one or more types of memory components. Secondary storage may be comprised of one or more disk drives or tape drives and is used for non-volatile storage of data and as an over-flow data storage device if RAM is not large enough to hold all working data. Secondary storage may be used to store programs which are loaded into RAM when such programs are selected for execution. ROM is used to store instructions and perhaps data which are read during program execution. ROM is a non-volatile memory device which typically has a small memory capacity relative to the larger memory capacity of secondary storage. RAM is used to store volatile data and perhaps to store instructions. Access to both ROM and RAM is typically faster than to secondary storage. Secondary storage, the RAM, and/or the ROM may be referred to in some contexts as computer readable storage media and/or non-transitory computer readable media.

Display 912 provides visual feedback to a customer. Display 912 may be a liquid crystal display, plasma display, organic light-emitting diode display, and/or other suitable display. In embodiments where display 912 is used as an input, the display may include one or more touch or input sensors, such as capacitive touch sensors, a resistive grid, or the like.

The I/O interface 908 allows a customer to enter data into the system 900, as well as providing an input/output for the system 900 to communicate with other devices or services. The I/O interface 908 can include one or more input buttons, touch pads, and so on. I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices may enable the processor to communicate with the Internet or one or more intranets. With such a network connection, it is contemplated that the processor might receive information from the network or might output information to the network in the course of performing the above-described method steps.

Such information, which may include data or instructions to be executed using a processor for example, may be received from and output to the network, for example, in the form of a computer data baseband signal or signal embodied in a carrier wave. The baseband signal or signal embedded in the carrier wave, or other types of signals currently used or hereafter developed, may be generated according to several methods known to one skilled in the art.

In some cases, and with reference to FIG. 9B, the system 900 may be implemented over a distributed network 950. The distributed network may include or otherwise facilitate communication with a plurality of customer devices 958a-958c in communication with one another via a network 954. In the implementation of FIG. 9B, the network 954 may include the server of system 900 to facilitate the communication amount the customer device 958a-958c and to perform one or more of the operations described herein. The server, or other network enabled device, may include substantially any type of computing device but typically may be one or more computing devices in communication with one another that perform one or more tasks for the customer devices 958a-958c. In some embodiments, the server may be a computing device that hosts a web server application or other software application that transmits and receives data to and from the customer devices 958a-958c. For example, such server may typically include one or more processing elements, memory components, and networking/communication interfaces, but may generally have a larger processing power and memory storage as compared to the client or customer devices 958a-958c.

The customer devices 958a-958c may also be substantially any type of computing device. In many embodiments the customer devices 958a-958c are portable computing devices with an integrated display, such as a smart phone. It should be noted that in many embodiments, the distributed network 950 may include a querying customer device and responsive or member customer devices. The customer devices 958a-958b may be configured to display the dashboard and/or any of the customer interfaces described herein. It is understood that by programming and/or loading executable instructions onto the computer system, at least one of the CPU, the RAM, and the ROM are changed, transforming the computer system in part into a particular machine or apparatus having the novel functionality taught by the present disclosure.

In some aspects, systems, methods, and computer-readable mediums are provided according to one or more of the following examples:

Example 1: A system for predicting human behavior across multiple domains, includes a multimodal encoder configured to receive and process text, image, audio, and video contextual data. The multimodal encoder includes a plurality of modality specific sub encoders that generate modality specific embeddings and a feature fusion module configured to combine the modality specific embeddings into a unified representation. The system includes a transformer architecture communicably coupled to the multimodal encoder, the transformer architecture including a plurality of self-attention mechanisms configured to generate context aware representations from the unified representation. The system includes a plurality of task specific output heads communicably coupled to the transformer architecture, each output head corresponding to a domain out of the multiple domains. Each output head is configured to generate a probability distribution of next human actions based on the context aware representations.

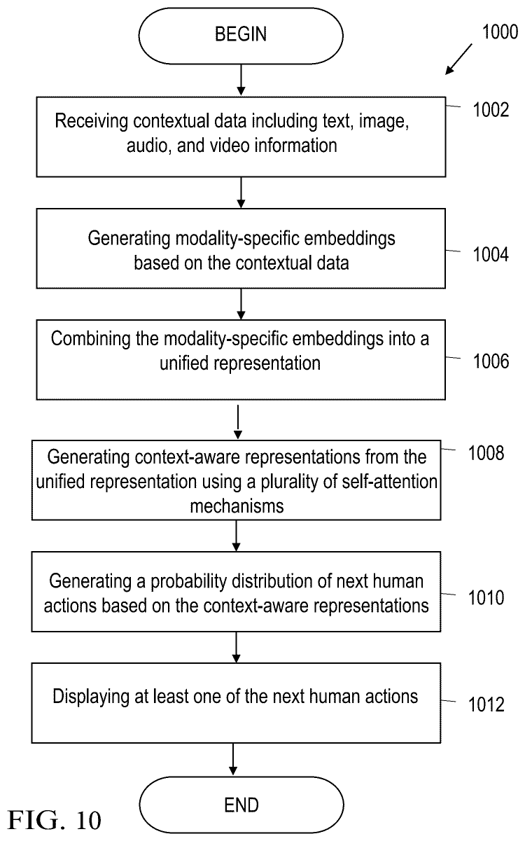

Example 2: FIG. 10 illustrates a method 1000 for predicting human behavior using multimodal contextual data. The method 1000 includes receiving 1002 contextual data including text, image, audio, and video information and generating 1004 modality-specific embeddings based on the contextual data. The method further includes combining 1006 the modality-specific embeddings into a unified representation and generating 1008 context-aware representations from the unified representation using a plurality of self-attention mechanisms. The method further includes generating 1010 a probability distribution of next human actions based on the context-aware representations and displaying 1012 at least one of the next human actions.

Example 3: A non-transitory computer-readable medium stores instructions that, when executed by one or more processors, cause the one or more processors to receive contextual data including text, image, audio, and video information and generate modality specific embeddings based on the contextual data and combine the modality-specific embeddings into a unified representation. The one or more processors are further caused to generate context aware representations from the unified representation using a plurality of self attention mechanisms and generate a probability distribution of next human actions based on the context aware representations.

The following features may be incorporated into the various embodiments described above, such features incorporated either individually in or conjunction with one or more of the other features: The system may include a reinforcement learning module communicably coupled to the output heads, the reinforcement learning module configured to update parameters of the transformer architecture and the task-specific output heads based on feedback associated with real-world outcomes. Generating the probability distribution may include generating the probability distribution with a 95th percentile latency of less than 200 milliseconds for text contextual data and less than 5 seconds for text, image, audio, and video contextual data. The multimodal encoder may include a cross-modal attention mechanism configured to enable features extracted from a first modality to influence attention weights applied to a second modality. Generating the probability distribution may include generating an ordered ranking of next human actions, and each action may include a confidence score derived from entropy-based uncertainty estimation such that the probability distribution includes a prioritized list of next human actions. The system may include an entropy-based uncertainty estimation module communicably coupled to the output heads, and the estimation module may be configured to compute an entropy value for each next human action and to classify any next human action with a corresponding entropy value exceeding an entropy threshold as low-confidence. The self-attention mechanisms may be designed for language processing, but the transformer architecture may be configured to represent each next human action as a discrete token rather than each token representing a linguistic unit. The multiple domains may include financial services, retail commerce, healthcare, and education, and domain adaptation may occur at the output heads while transformer architecture weights remain shared across the multiple domains. The method may include updating the probability distribution based on feedback associated with real-world outcomes. Generating the probability distribution may include generating the probability distribution with a 95th percentile latency of less than 200 milliseconds for text contextual data and less than 5 seconds for text, image, audio, and video contextual data. Generating the probability distribution may include generating an ordered ranking of next human actions, and each action may include a confidence score derived from entropy-based uncertainty estimation such that the probability distribution includes a prioritized list of next human actions. The method may include computing an entropy value for each next human action and classifying any next human action with a corresponding entropy value exceeding an entropy threshold as low-confidence. The self-attention mechanisms may be designed for language processing, but generating context-aware representations may include representing each next human action as a discrete token rather than each token representing a linguistic unit. The method may include updating the probability distribution based on feedback associated with real-world outcomes. The computer readable medium may further include instructions that, when executed by the one or more processors, cause the processors to perform any applicable action described herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein. Numerous other modifications, equivalents, and alternatives, will become apparent once the above disclosure is fully appreciated. It is intended that the following claims be interpreted to embrace all such modifications, equivalents, and alternatives where applicable.

What is claimed is:

1. A system for predicting human behavior across multiple domains, comprising:
a multimodal encoder configured to receive and process text, image, audio, and video contextual data, the multimodal encoder comprising a plurality of modality-specific sub-encoders that generate modality-specific embeddings, the multimodal encoder comprising a feature fusion module configured to combine the modality-specific embeddings into a unified representation;
a transformer architecture communicably coupled to the multimodal encoder, the transformer architecture comprising a plurality of self-attention mechanisms configured to generate context-aware representations from the unified representation; and
a plurality of task specific output heads communicably coupled to the transformer architecture, each output head corresponding to a domain out of the multiple domains, and each output head configured to generate a probability distribution of next human actions based on the context-aware representations.

2. The system of claim 1, further comprising a reinforcement learning module communicably coupled to the output heads, the reinforcement learning module configured to update parameters of the transformer architecture and the task-specific output heads based on feedback associated with real-world outcomes.

3. The system of claim 1, wherein generating the probability distribution comprises generating the probability distribution with a 95th percentile latency of less than 200 milliseconds for text contextual data and less than 5 seconds for text, image, audio, and video contextual data.

4. The system of claim 1, wherein the multimodal encoder includes a cross-modal attention mechanism configured to enable features extracted from a first modality to influence attention weights applied to a second modality.

5. The system of claim 1, wherein generating the probability distribution comprises generating an ordered ranking of next human actions, each action including a confidence score derived from entropy-based uncertainty estimation such that the probability distribution comprises a prioritized list of next human actions.

6. The system of claim 1, further comprising an entropy-based uncertainty estimation module communicably coupled to the output heads, the estimation module configured to compute an entropy value for each next human action and to classify any next human action with a corresponding entropy value exceeding an entropy threshold as low-confidence.

7. The system of claim 1, wherein the self-attention mechanisms are designed for language processing, but the transformer architecture is configured to represent each next human action as a discrete token rather than each token representing a linguistic unit.

8. The system of claim 1, wherein the multiple domains comprise financial services, retail commerce, healthcare, and education, and wherein domain adaptation occurs at the output heads while transformer architecture weights remain shared across the multiple domains.

9. A method for predicting human behavior using multimodal contextual data, comprising:
receiving contextual data including text, image, audio, and video information;
generating modality-specific embeddings based on the contextual data;
combining the modality-specific embeddings into a unified representation;
generating context-aware representations from the unified representation using a plurality of self-attention mechanisms;
generating a probability distribution of next human actions based on the context-aware representations; and
displaying at least one of the next human actions.

10. The method of claim 9, further comprising updating the probability distribution based on feedback associated with real-world outcomes.

11. The method of claim 9, wherein generating the probability distribution comprises generating the probability distribution with a 95th percentile latency of less than 200 milliseconds for text contextual data and less than 5 seconds for text, image, audio, and video contextual data.

12. The method of claim 9, wherein generating the probability distribution comprises generating an ordered ranking of next human actions, each action including a confidence score derived from entropy-based uncertainty estimation such that the probability distribution comprises a prioritized list of next human actions.

13. The method of claim 9, further comprising computing an entropy value for each next human action and classifying any next human action with a corresponding entropy value exceeding an entropy threshold as low-confidence.

14. The method of claim 9, wherein the self-attention mechanisms are designed for language processing, but generating context-aware representations comprises representing each next human action as a discrete token rather than each token representing a linguistic unit.

15. The method of claim 9, further comprising updating the probability distribution based on feedback associated with real-world outcomes.

16. A non-transitory computer-readable medium storing instructions that, when executed by one or more processors, cause the one or more processors to:
receive contextual data including text, image, audio, and video information;
generate modality-specific embeddings based on the contextual data;
combine the modality-specific embeddings into a unified representation;
generate context-aware representations from the unified representation using a plurality of self-attention mechanisms; and
generate a probability distribution of next human actions based on the context-aware representations.

17. The non-transitory computer-readable medium of claim 16, wherein the self-attention mechanisms are designed for language processing, but generating context-aware representations comprises representing each next human action as a discrete token rather than each token representing a linguistic unit.

18. The non-transitory computer-readable medium of claim 16, wherein generating the probability distribution comprises generating an ordered ranking of next human actions, each action including a confidence score derived from entropy-based uncertainty estimation such that the probably distribution comprises a prioritized list of next human actions.

19. The non-transitory computer-readable medium of claim 16, wherein generating the probability distribution comprises generating the probability distribution with a 95th percentile latency of less than 200 milliseconds for text contextual data and less than 5 seconds for text, image, audio, and video contextual data.

20. The non-transitory computer-readable medium of claim 16, wherein the instructions further cause the one or more processors to dynamically adjust temperature and beam size during distribution generation to reduce overconfidence and increase diversity of next human actions.
